(19) United States
(12) Patent Application Publication
(10) Pub. No.: US 2024/0111564 A1
(43) Pub. Date: Apr. 4, 2024

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Kazuya YAMAMOTO, Tokyo (JP)

(73) Assignee: NEC Corporation, Tokyo (JP)

(21) Appl. No.: 18/370,482

(22) Filed: Sep. 20, 2023

(30) Foreign Application Priority Data
Sep. 30, 2022 (JP) 2022-157305

(51) Int. Cl. G06F 9/455

(52) U.S. Cl. CPC G06F 9/45558; G06F 2009/45562; G06F 2009/4557

(57) ABSTRACT

An information processing apparatus including: an obtaining unit that obtains, for each of a plurality of computers in which software that supports a multi-session model and is accessed and used by a plurality of users is installed, use history information indicating use histories of the users that use the computers; a generation unit that generates, for each computer, reference use history information indicating a use history serving as a reference for the computer, using the use history information of the users that use the computer; and an extraction unit that calculates, for each user that uses the computers, similarities between the use history information of the user and the pieces of reference use history information of the computers, and extracting a computer corresponding to the user based on the similarities.

### CROSS-REFERENCE TO RELATED APPLICATION

This application is based upon and claims the benefit of priority from Japanese patent application No. 2022-157305, filed on Sep. 30, 2022, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium.

### 2. Background Art

Among VDI (Virtual Desktop Infrastructure) services, DaaS (Desktop as a Service) is known as a service for deploying a desktop environment on a cloud. In addition, the DaaS model provides a single-session model and a multi-session model. AVD (Azure Virtual Desktop: registered trademark) and the like are known multi-session models.

With the single-session model, an OS (Operating System) that supports the single-session model is installed in each virtual machine constructed on a virtual infrastructure (hypervisor). In addition, in a system that employs the single-session model, one user (one thin client terminal apparatus) is allocated to one virtual machine. Furthermore, the single-session OS provides this thin client terminal apparatus with a virtual desktop that is compatible therewith.

In contrast, with the multi-session model, an OS that supports the multi-session model is installed in each virtual machine constructed on a virtual infrastructure. In addition, in a system that employs the multi-session model, the thin client terminal apparatuses of a plurality of users are allocated to one virtual machine. Furthermore, the multi-session OS provides a virtual desktop to each of the thin client terminal apparatuses connected to the virtual machine in which the multi-session OS is installed.

Therefore, in the multi-session model, the users of the plurality of thin client terminal apparatuses connected to the virtual machine in which the multi-session OS is installed perform various operations. For this reason, when a security patch that requires a restart is applied to the multi-session OS, operations performed by the users are affected if the restart timing is not appropriate.

As a related technique, Japanese Patent Laid-Open Publication No. 2019-087010 discloses a restart control system that includes an information processing apparatus and a restart management apparatus. The restart management apparatus sets a restart time of the information processing apparatus based on apparatus management information that includes information regarding the information processing apparatus and another information processing apparatus that is in a proximal relationship with the information processing apparatus. In addition, the restart management apparatus transmits restart times to the information processing apparatuses. Furthermore, the information processing apparatuses execute a restart at the transmitted restart times.

In addition, as a related technique, Japanese Patent Laid-Open Publication No. 2014-021812 discloses a connection state management apparatus that changes a connection state between a client and a server at an appropriate timing, and manages the connection state so as not to cause inconsistency between held data and the processing state of a user that operates the client. When a request to change a connection state is given, the connection state management apparatus in Japanese Patent Laid-Open Publication No. 2014-021812 obtains, from function information, data indicating whether or not a function that is being used by the user is a function that can forcefully change a connection state, and changes the connection state if the function is a function that can change a connection state.

As another related technique, Japanese Patent Laid-Open Publication No. 10-027146 discloses a communication processing apparatus that manages sessions between hosts and terminals, and prevents a load from concentrating on a specific host by recognizing the load states of application programs (APs) on hosts and opening a session between terminals and APs on a host that has the lightest load. When a failure occurs on the host, the communication processing apparatus in Japanese Patent Laid-Open Publication No. 10-027146 determines a reconnection destination of a session for each AP in consideration of the load states of hosts, and automatically performs reconnection of a session.

However, the techniques in Japanese Patent Laid-Open Publications Nos. 2019-087010, 2014-021812, and 10-027146 are not directed toward reducing the influence on users as much as possible when a security patch that requires a restart is applied to an OS that supports the multi-session model.

### SUMMARY

An example object of the present disclosure is to reduce the influence on users when a security patch that requires a restart is applied to software that supports a multi-session model.

In order to achieve the above object, an information processing apparatus according to one aspect of the present disclosure includes:
an obtaining unit that obtains, for each of a plurality of computers in which software that supports a multi-session model and is accessed and used by a plurality of users is installed, use history information indicating use histories of the users that use the computers;
a generation unit that generates, for each computer, reference use history information indicating a use history serving as a reference for the computer, using the use history information of the users that use the computer; and
an extraction unit that calculates, for each user that uses the computers, similarities between the use history information of the user and the pieces of reference use history information of the computers, and extracts a computer corresponding to the user based on the similarities.

Also, in order to achieve the above object, an information processing method according to one aspect of the present disclosure is performed by an information processing apparatus, the method comprising:
obtaining, for each of a plurality of computers in which software that supports a multi-session model and is accessed and used by a plurality of users is installed, use history information indicating use histories of the users that use the computers;
generating, for each computer, reference use history information indicating a use history serving as a reference for the computer, using the use history information of the users that use the computer; and
calculating, for each user that uses the computers, similarities between the use history information of the user and the pieces of reference use history information of the computers, and extracting a computer corresponding to the user based on the similarities.

Furthermore, in order to achieve the above object, a computer-readable recording medium according to one aspect of the present disclosure includes a program recorded thereon, the program including instructions that causes a computer to carry out:
obtaining, for each of a plurality of computers in which software that supports a multi-session model and is accessed and used by a plurality of users is installed, use history information indicating use histories of the users that use the computers;
generating, for each computer, reference use history information indicating a use history serving as a reference for the computer, using the use history information of the users that use the computer; and
calculating, for each user that uses the computers, similarities between the use history information of the user and the pieces of reference use history information of the computers, and extracting a computer corresponding to the user based on the similarities.

As described above, according to the present disclosure, when a security patch that requires a restart is applied to software that supports the multi-session model, influence on users can be reduced.

### BRIEF DESCRIPTION OF THE DRAWINGS

FIG. 1 is a diagram illustrating an example of an information processing apparatus.

FIG. 2 is a diagram for describing an example of a system that includes the information processing apparatus.

FIG. 3 is a diagram for describing the configuration of the information processing apparatus in detail.

FIG. 4 is a diagram for describing an example of the data structure of use history information.

FIG. 5 is a diagram for describing a method for detecting non-use period.

FIG. 6 is a diagram for describing a method for setting a restartable period.

FIG. 7 is a diagram for describing the relation between use history information and reference use history information.

FIG. 8 is a diagram for describing an example of use histories.

FIG. 9 is a diagram for describing generation of daily reference use history information.

FIG. 10 is a diagram for describing generation of weekly reference use history information.

FIG. 11 is a diagram for describing first similarities.

FIG. 12 is a diagram for describing second similarities.

FIG. 13 is a diagram for describing content of notification.

FIG. 14 is a diagram for describing operations of the information processing apparatus.

FIG. 15 is a diagram for describing an example of a computer that realizes the information processing apparatus.

### EXEMPLARY EMBODIMENTS

Hereinafter, example embodiments will be described with reference to the drawings. Note that, in the drawings described below, elements having the same functions or corresponding functions are denoted by the same reference numerals, and repeated description thereof may be omitted.

### Example Embodiment

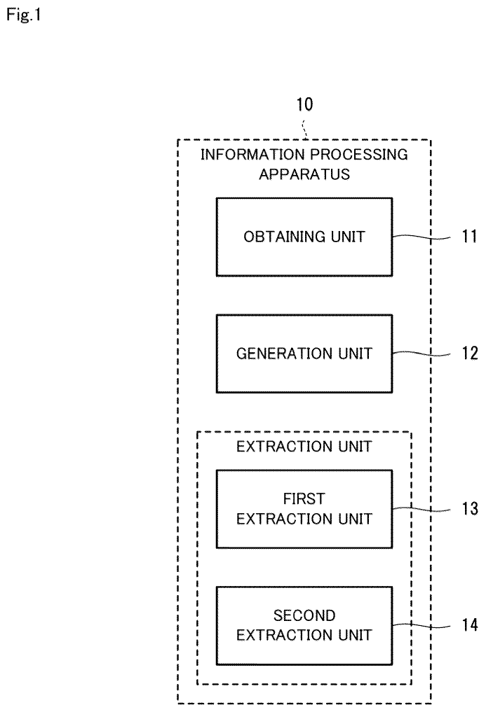

A configuration of an information processing apparatus 10 according to an example embodiment will be described with reference to FIG. 1. FIG. 1 is a diagram illustrating an example of the information processing apparatus.

[Apparatus Configuration]

Even when a security patch that requires a restart is applied to software that supports a multi-session model, the information processing apparatus 10 shown in FIG. 1 restarts a computer so as not to affect use by users. In addition, as shown in FIG. 1, the information processing apparatus 10 includes an obtaining unit 11, a generation unit 12, a first extraction unit 13, and a second extraction unit 14.

The security patch is a program for correcting vulnerability of the multi-session software. There are cases where vulnerability, a security hole, and the like are found in publicly available OSs and applications, and thus, the software is corrected using a security patch in order to protect the information processing apparatus 10 from malware, cyberattacks, and the like. Note that the security patch is distributed by a vendor or the like when vulnerability is found.

The obtaining unit 11 obtains use history information indicating use histories of users that use a plurality of computers in which multi-session software that is accessed and used by a plurality of users.

The computer may be a virtual machine, hardware, or the like installed in the information processing apparatus 10, for example. Note that a case will be described below in which the computer is a virtual machine.

The multi-session model is a method for allowing a plurality of users to share and use multi-session software that is implemented in a virtual machine or the like. Note that the multi-session model may be realized by the DaaS model.

The multi-session software is an OS or application software that supports the multi-session model and is installed in a virtual machine or the like. Note that, hereinafter, application software may be referred to as an “application” or “app”.

The virtual machine is a computer that realizes, with software, similar functions to those of a physical computer. In addition, the virtual machine executes an OS and applications similarly to a physical computer.

The generation unit 12 generates reference use history information indicating a use history serving as a reference for each virtual machine, using use history information of users that use the virtual machine. Specifically, the generation unit 12 averages use contents of a plurality of users that share each virtual machine and generates reference use history information, using use histories of the users during a period set in advance.

The set period is one day (24-hour period of a certain day of the week), a weekday period (period from Monday to Friday), one week (period from Sunday to Saturday), one month (period from the first day to the last day of a month), or the like.

Furthermore, the set period may be one day, a weekday period, one week, or one month that is based on the most recent past day of the week that is the same as the day of the current point in time. If, for example, the day of the current point in time is Monday, the previous Monday is used as a reference, and thus Monday of last week is used as one day. In addition, the weekday period is a period from Monday to Friday of last week. One week is a period from Monday to Sunday of last week. One month is a period from the same date of last month as the date of the current point in time to a date that is one day before the current point in time.

In averaging, for example, if the set period is one day, the number of users for each use content is calculated using use contents executed by a plurality of users in the same time zone (for example, one hour) on the same date or the same day of the week, and a use content executed by the largest number of users is selected. When, for example, users 1 and 2 execute the use content of Task 1 and a user 3 executes the use content of Task 2 during a certain period (for example, 8:00 to 9:00 on Monday), a use content during the period obtained as a result of averaging is Task 1. Note that averaging is performed also with respect to the aforementioned weekday period, one week, and one month in a similar manner.

In other words, it can also be said that averaging is deleting a use content that occurs on irregular basis. Averaging is, for example, processing for deleting a meeting (use content) that is suddenly held, and replacing the meeting (use content) with a use content executed by a large number of users in a period in which the meeting (use content) was held.

The extraction unit calculates similarities between use history information of each user that uses a virtual machine and pieces of reference use history information of respective computers, and extracts a computer corresponding to the user based on the similarities. Note that the extraction unit includes a first extraction unit 13 and the second extraction unit 14.

The first extraction unit 13 calculates first similarities between reference use history information of each virtual machine and pieces of use history information of a plurality of users that share the virtual machine, detects a first similarity that is equal to or smaller than a first threshold value set in advance, from among the calculated first similarities, and extracts first users corresponding to the detected first similarity.

That is to say, the first extraction unit 13 extracts first users that have use histories that are not similar to the reference use history information of the target virtual machine.

The second extraction unit 14 calculates second similarities between reference use history information of each of other virtual machines and pieces of use history information of the extracted first users, detects a second similarity that is equal to or larger than a second threshold value set in advance, from among the calculated second similarities, and extracts a second user corresponding to the detected second similarity and another virtual machine corresponding to the second user.

That is to say, the second extraction unit 14 compares the pieces of reference use history information of virtual machines other than the target virtual machine, with the use histories of the extracted first users, and extracts a first user corresponding to a similar use history (second user).

Next, the administrator that manages multi-session software is notified that there is another virtual machine corresponding to a large number of users performing use that is similar to use by the second user. The administrator then changes the connection between the virtual machine and the terminal apparatuses of the users, based on the notification.

As described above, in the example embodiment, when a security patch that requires a restart is applied to multi-session software, influence on users can be reduced.

In addition, it is possible to change the sharing relation between users and virtual machines based on similarity in use content, and thus a restart of a virtual machine can be efficiently executed. That is to say, the use contents of users that share a virtual machine are similar, and thus a restart of the virtual machine can be efficiently executed.

[System Configuration]

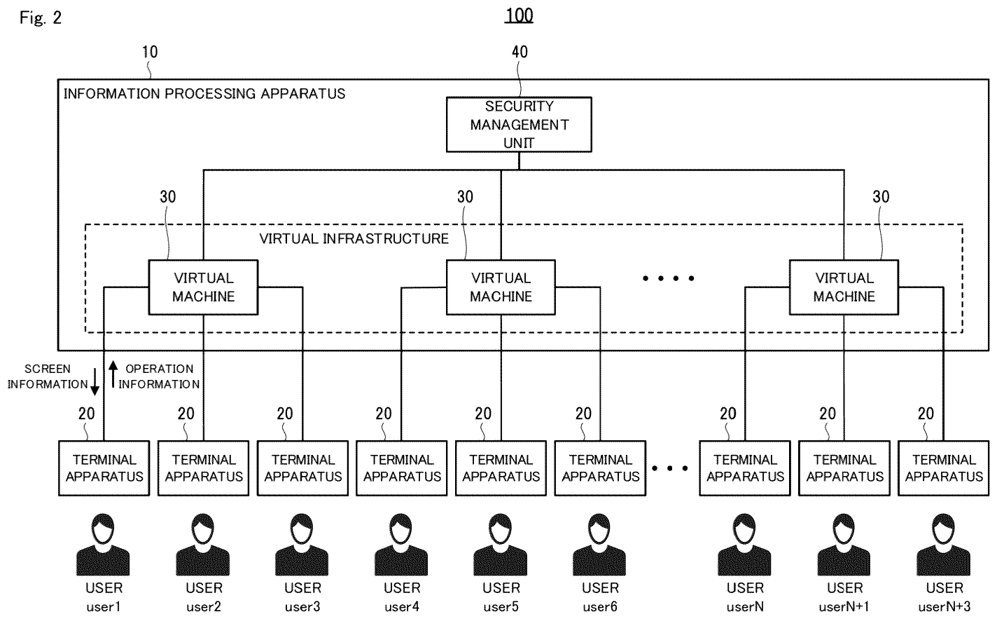

The configuration of the information processing apparatus 10 according to the example embodiment will be described in more detail with reference to FIG. 2. FIG. 2 is a diagram for describing an example of a system that includes the information processing apparatus.

In the example in FIG. 2, a system 100 includes the information processing apparatus 10 and a plurality of terminal apparatuses 20. In addition, the information processing apparatus 10 is connected to the plurality of terminal apparatuses 20 via a network.

The information processing apparatus 10 is a CPU (Central Processing Unit), a programmable device such as an FPGA (Field-Programmable Gate Array), a GPU (Graphics Processing Unit), a circuit on which one or more thereof are mounted, a server computer, or the like. In addition, the information processing apparatus 10 includes one or more virtual machines 30 and a security management unit 40.

Each terminal apparatus 20 is a CPU, a programmable device such as an FPGA, a GPU, a circuit on which one or more thereof are mounted, a general client terminal apparatus (a personal computer, a tablet, a smartphone, etc.), a thin client terminal apparatus, or the like.

The thin client terminal apparatus is a terminal apparatus obtained by removing a large-capacity storage medium (HDD (Hard Disk Drive), SSD (Solid State Drive)) from a client terminal apparatus, for example.

The network is, for example, a general communication network constructed using a communication line such as the Internet, a LAN (Local Area Network), a dedicated line, a phone line, an intranet, a mobile communication network, Bluetooth (registered trademark), Wi-Fi (Wireless Fidelity)(registered trademark), or the like.

The virtual machines 30 are constructed on a virtual infrastructure of the information processing apparatus 10. Each of the virtual machines 30 transmits, to the terminal apparatuses 20, screen information indicating screen content of a virtual desktop that is used by the users. The virtual machine 30 receives, from each terminal apparatus 20, operation information indicating operation content of the terminal apparatus 20 of the user. The operation content is information input from an input device such as a keyboard, a mouse, or a touch panel, for example.

When vulnerability is found in multi-session software installed in the virtual machine 30, the security management unit 40 manages information regarding the security distributed by a vendor. In addition, the security management unit 40 corrects the vulnerability of the software using a security patch, and generates an instruction for restarting the virtual machine 30. The security management unit 40 then transmits the generated instruction to the virtual machine 30. The information processing apparatus 10 will be described in detail.

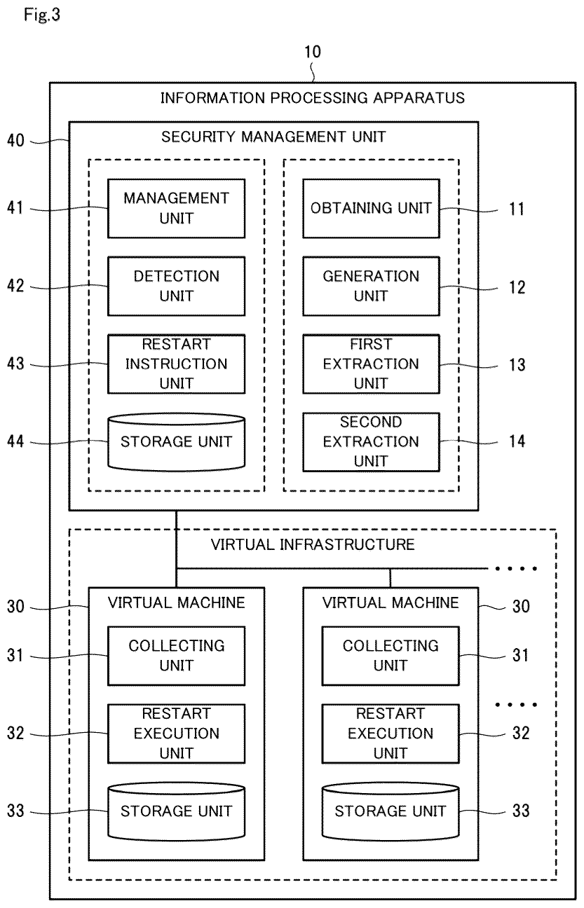

FIG. 3 is a diagram for describing the configuration of the information processing apparatus in detail. In the example in FIG. 3, each of the plurality of virtual machines 30 includes a collecting unit 31, a restart execution unit 32, and a storage unit 33. The security management unit 40 includes the obtaining unit 11, the generation unit 12, the first extraction unit 13, the second extraction unit 14, a management unit 41, a detection unit 42, a restart instruction unit 43, and a storage unit 44.

Note that, in the example in FIG. 3, the storage unit 33 and the storage unit 44 are separate from each other, but the storage unit 33 and the storage unit 44 may be a single storage unit. Furthermore, in the example in FIG. 3, the storage unit 33 and the storage unit 44 are provided in the information processing apparatus 10, but may be provided outside the information processing apparatus 10.

In addition, in the example in FIG. 3, the collecting unit 31, the restart execution unit 32, and the storage unit 33 are mounted in each of the virtual machines 30, but may be provided outside the virtual machine 30.

Description of Virtual Machine 30

The collecting unit 31 collects use history information of the users sharing the virtual machine 30, at an interval set in advance, and stores the use history information to the storage unit 33 for each of the users sharing the virtual machine 30.

The interval set in advance is an interval of a few minutes, a few hours, or the like. Note that the collecting unit 31 may collect use history information using a collecting function of an agent implemented in the virtual machine 30.

In addition, the collecting unit 31 transmits the collected use history information to the security management unit 40. Upon receiving the use history information, the management unit 41 of the security management unit 40 stores, to the storage unit 44, the use history information of the users sharing virtual machines 30, for each of the virtual machines 30. Note that the use history information does not need to be stored in the storage unit 33, and may be stored in the storage unit 44.

The use history information is information obtained by associating user identification information for identifying each user, use specifying information for specifying a use content, use period information indicating the period of the use content, and operation identification information for identifying an operation performed in the use content with each other.

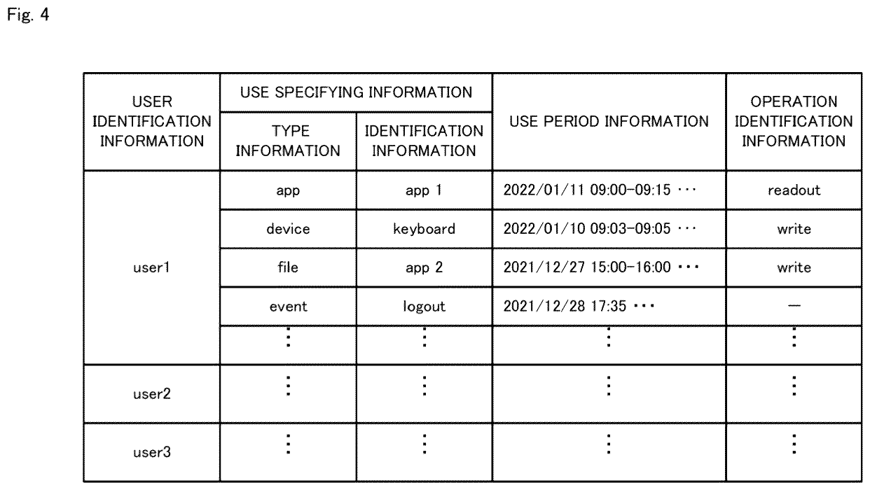

FIG. 4 is a diagram for describing an example of the data structure of the use history information. The example in FIG. 4 shows the use history information of the users (users 1 to 3) of one of the virtual machines 30 shown in FIG. 2. Note that the use history information of the users (users 4 to 6 . . . user N to user N+3) of another virtual machine 30 shown in FIG. 2 is also stored in the storage unit 33 or 44, similarly to the use history information in FIG. 4.

The user identification information in FIG. 4 stores “user 1”, “user 2”, and “user 3”, namely, information for identifying the users sharing the one virtual machine 30. Note that the number of users sharing the virtual machine 30 is not limited to three.

The use specifying information in FIG. 4 includes type information indicating the type of software, hardware and files used by the user (user 1), and the type of events that occurred due to operations by the user, and identification information for identifying software, hardware, and files used by the user (user 1), events that occurred due to operations by the user, and the like.

The type information stores “app” indicating a type of application (software), “device” indicating a type of input device (hardware), “file” indicating a type of file, “event” indicating a type of event, and the like. Note that the type information is not limited to the above types.

The identification information stores “app 1” indicating that the used application (software) is a communication tool, “keyboard” indicating that the used input device (hardware) is a keyboard, “app 2” indicating that the used file is a file that is used for a table calculation app, “logout” indicating that the event is logout, and the like.

Note that the identification information is not limited to the above “app 1”, “keyboard”, “app 2”, and “logout”.

The use period information in FIG. 4 stores periods “2022/01/11 09:00-09:15 . . . ”, “2022/01/10 09:03-09:05 . . . ”, and “2021/12/27 15:00-16:00” in which the user used the above application “app 1”, input device “keyboard”, and file “app 2”, respectively, and a time “2021/12/28 17:35 . . . ” when the user logged out.

The operation identification information in FIG. 4 stores “readout” indicating a function process (mode) when the above application “app 1” was executed, “write” indicating a function process (mode) when the input device “keyboard” was used, and “write” indicating a function process (mode) when a file “app 2” was executed. Note that there is no function process (mode) when the event “logout” was executed, and thus, in the example in FIG. 4, “-” is entered.

In addition, the operation identification information in FIG. 4 includes information indicating function processes (modes), but may include information indicating states of use. Information indicating a state of use stores the state of a user such as “phone” or “chat” indicating that the user is talking on the phone or chatting online when the user performs an operation on the application “app 1”, for example. When the user is inputting data by performing an operation on the input device “keyboard”, “input” indicating the state of the user, or the like is stored. When the file “app 2” is opened by the user, “open” indicating a state where the file has been opened by the user, or the like is stored.

Note that the information indicating the states of use is not limited to “phone”, “chat”, “input”, and “open” described above.

Before a restartable period, the restart execution unit 32 receives, from the restart instruction unit 43, an instruction for applying a security patch to the software of a target virtual machine 30 and for restarting the target virtual machine 30 in the restartable period, applies the security patch based on the received instruction, and restarts the virtual machine 30 in the restartable period.

In addition, when restarting the target virtual machine 30, the restart execution unit 32 may notify the terminal apparatuses 20 of all of the users sharing the target virtual machine 30 that the target virtual machine 30 is to be restarted. This is because there is the possibility that the target virtual machine 30 is being used by a user, and thus, it is highly likely that a sudden restart will cause trouble with use. In addition, a notification requesting that files that are being used be stored may be added to the notification.

The storage unit 33 stores use history information of the users sharing the virtual machine 30 collected by the collecting unit 31.

Description of Security Management Unit 40

(A) Applying a Security Patch and Restarting a Virtual Machine Will be Described.

Applying a security patch and restarting a virtual machine 30 are executed using the management unit 41, the detection unit 42, the restart instruction unit 43, and the storage unit 44

The management unit 41 obtains, via the network, a security patch distributed from a vendor or the like, and a restart required time information regarding the time required for a restart in order to apply the security patch, and stores the security patch and the restart required time information to the storage unit 44.

In applying a security patch to multi-session software that is accessed and used by a plurality of users, if the virtual machine 30 needs to be restarted, the detection unit 42 detects one or more non-use period that are equal to or longer than a time required for a restart and in which none of the users are using the virtual machine 30, using the restart required time information indicating the time required for a restart, and the use history information indicating use histories of the users of the virtual machine 30.

The detection unit 42 first obtains the information regarding the time required for a restart, from the storage unit 44. In addition, the detection unit 42 obtains, from the storage unit 44, the use history information of the users sharing the target virtual machine 30.

Next, the detection unit 42 detects one or more non-use period that are equal to or longer than the time required for a restart and in which none of the users were using the target virtual machine 30, using the restart required time information regarding the time required for a restart and the use history information.

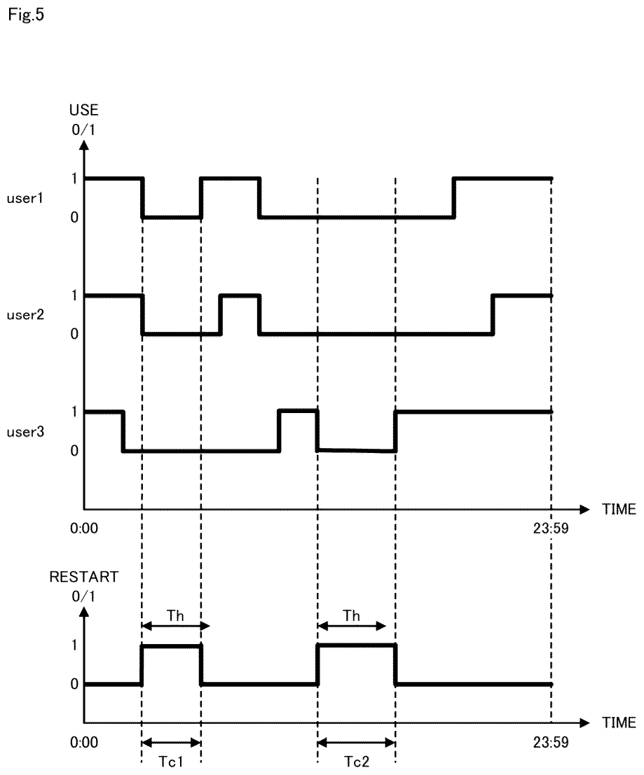

A method for detecting non-use period will be described with reference to FIG. 5.

FIG. 5 is a diagram for describing a method for detecting non-use period. In the example in FIG. 5, the detection unit 42 detects periods (unused periods) in which the users (users 1 to 3) sharing the virtual machine 30 were not using the virtual machine 30, using the use history information of the users (users 1 to 3).

Specifically, in the case of the users (users 1 to 3), use periods and unused periods of each of the users (users 1 to 3) are obtained. In the case of the user (user 1), for example, a use period and an unused period in a detection period set in advance are obtained using the use history information of the user (user 1).

It is conceivable to use the 24-hour period (0:00 to 23:59) of one of the days in the past one week, as the detection period, for example. In addition, use periods and unused periods in the past one week may be obtained.

In addition, also in the case of the users (users 2 and 3), use periods and unused periods are obtained similarly to the above user (user 1).

Note that, in the example in FIG. 5, a use period and an unused period of each of the users (users 1 to 3) are respectively indicated by “1” and “0”.

Next, the detection unit 42 detects a common unused period in which the unused periods of the users (users 1 to 3) overlap. The example in FIG. 5 indicates that common unused periods Tc1 and Tc2 have been detected.

Next, the detection unit 42 determines whether or not each of the common unused periods Tc1 and Tc2 is equal to or longer than a time Th required for a restart. In the example in FIG. 5, the common unused period Tc 1 is shorter than the time Th required for a restart, and thus is not regarded as a non-use period. The common unused period Tc2 is longer than the time Th required for a restart, and thus is regarded as a non-use period.

The restart instruction unit 43 sets a restartable period to a period later than the current point of time based on the detected non-use periods, and gives an instruction for restarting the virtual machine 30 in the restartable period.

When, for example, none of the users sharing the virtual machine are using the virtual machine in a period from 8:00 am to 9:00 am on Monday in the past from the current point of time (Monday of the current week), and this period is longer than the time required for a restart (non-use period in FIG. 5), the restartable period is set to a period from 8:00 am to 9:00 am on Monday in the future from the current point of time (Monday of next week).

In addition, when, for example, one or more periods in which none of the users sharing the virtual machine were using the virtual machine in the past one week from the current point of time and that are longer than the time required for a restart (non-use periods) are detected, periods in the coming one week from the current point of time that correspond to the plurality of detected periods are set as restartable periods.

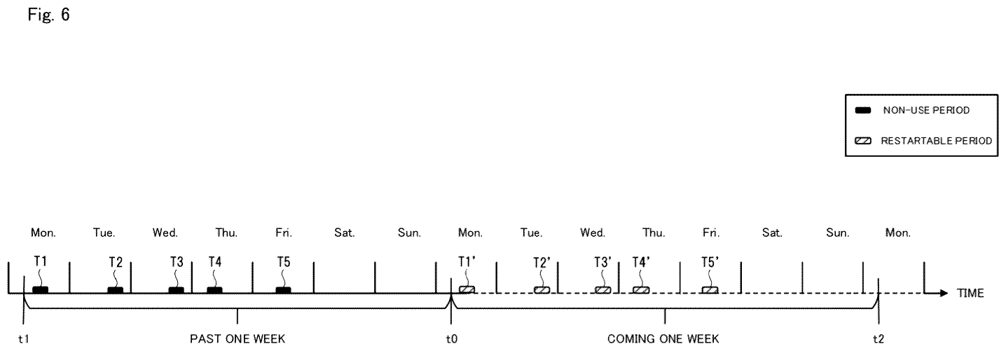

FIG. 6 is a diagram for describing a method for setting a restartable period. In the example in FIG. 6, it is assumed that the current time t0 is 8:00 am on Monday, and that as a result of detecting non-use periods in the past one week from 8:00 am on Monday of last week (time t1) until the current time to, non-use periods T1, T2, T3, T4, and T5 were detected.

In this case, in the example in FIG. 6, the detected non-use periods T1 to T5 are allocated to the coming one week from the present time t0 to 8:00 am on Monday of next week (time t2), based on the day and time, and restartable periods T1′, T2′, T3′, T4′, and T5′ are obtained.

The reason for setting a plurality of restartable periods is that there are cases where a restart cannot be performed in the restartable period T1′, and, in that case, the restart is desirably performed in the next restartable period T2′.

In addition, it is preferable to apply a security patch promptly, and thus it is desirable that restartable periods are selected in order from the restartable period that is closest to the present time t0.

Furthermore, when a plurality of restartable periods are set for a security patch, settings of the restartable periods are cancelled after a restart is performed in order to apply the security patch.

Next, before the restartable period, the restart instruction unit 43 transmits, to the restart execution unit 32 of the virtual machine 30, an instruction for applying a security patch to the software of the virtual machine 30 and for restarting the virtual machine 30.

The restart execution unit 32 then receives the instruction before the restartable period, and applies the security patch to the software of the virtual machine 30 and restarts the virtual machine in the restartable period based on the received instruction.

The storage unit 44 stores at least the security patch, the time that is required for a restart if the security patch is applied, the use history information of the users of the virtual machine 30, and the restartable period.

(B) Description of Change of Virtual Machines that is Based on Similarity in Use Content

Change of virtual machines that is based on similarity in use content is executed by using the obtaining unit 11, the generation unit 12, the first extraction unit 13, and the second extraction unit 14.

The obtaining unit 11 obtains, from the storage unit 44, use history information indicating use histories of a plurality of users that use each virtual machine 30.

The generation unit 12 generates reference use history information indicating a use history serving as a reference that represents each virtual machine 30, using use history information of a plurality of users that share the virtual machine 30, and stores the reference use history information to the storage unit 44.

Specifically, the generation unit 12 averages use contents of a plurality of users that share the virtual machine 30, using use histories of the plurality of users in a period set in advance, and generates reference use history information.

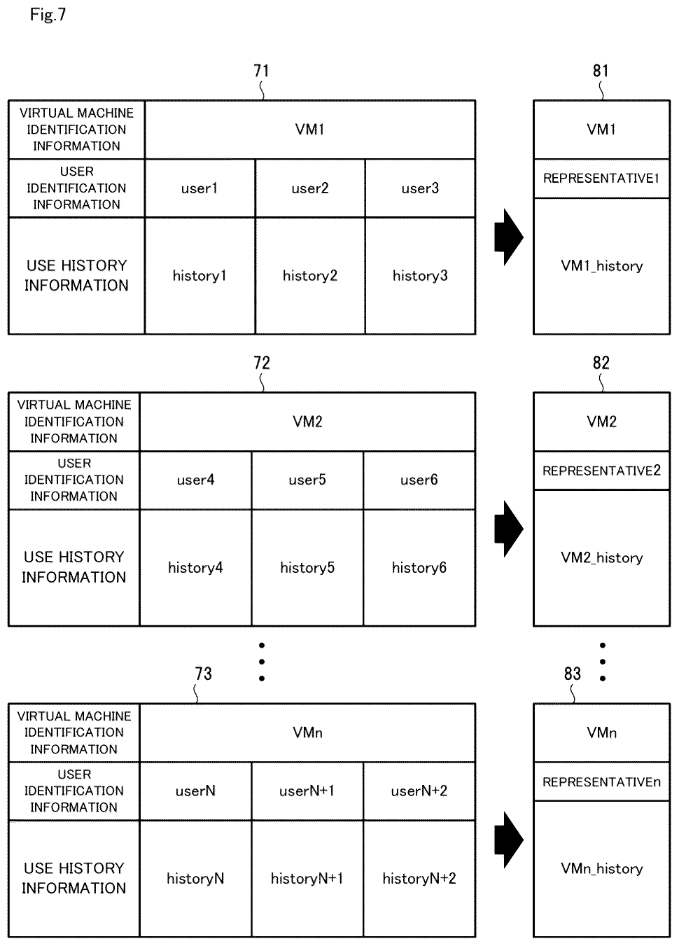

FIG. 7 is a diagram for describing the relation between use history information and reference use history information. FIG. 7 shows an example where reference use history information is generated for each of the virtual machines 30 shown in FIG. 2. Information 71, information 72, and information 73 shown in FIG. 7 are each information in which virtual machine identification information for identifying a virtual machine 30, user identification information for identifying users, and use history information of the users are associated with each other.

The virtual machine identification information in the information 71 in FIG. 7, stores “VM1”. In addition, the user identification information in the information 71 in FIG. 7 stores user identification information “user 1”, “user 2”, and “user 3” for identifying users that use the virtual machine. In addition, the use history information in the information 71 in FIG. 7 stores use history information “history 1”, “history 2”, and “history 3” of the users that share the virtual machine 30 (VM1).

The information 81 in FIG. 7 stores reference use history information VM1_history serving as a reference that represents the virtual machine 30 (VM1), and generated using the use histories of the users that share the virtual machine 30 (VM1).

The virtual machine identification information in the information 72 in FIG. 7 stores “VM2”. In addition, the user identification information in the information 72 in FIG. 7 stores user identification information “user 4”, “user 5”, and “user 6” for identifying the users that use the virtual machine. In addition, the use history information in the information 72 in FIG. 7 stores use history information “history 4”, “history 5”, and “history 6” of the users that share the virtual machine 30 (VM2).

The information 82 in FIG. 7 stores reference use history information VM2_history serving as a reference that represents the virtual machine 30 (VM2), and generated using the use histories of the users that share the virtual machine 30 (VM2).

The virtual machine identification information in the information 73 in FIG. 7 stores “VMn”. In addition, the user identification information in the information 73 in FIG. 7 stores user identification information “user N”, “user N+1”, and “user N+2” for identifying the users that use the virtual machine. In addition, the use history information in the information 73 in FIG. 7 stores use history information “history N”, “history N+1”, and “history N+2” of the users that share the virtual machine 30 (VMn).

The information 83 in FIG. 7 stores reference use history information VMn_history serving as a reference that represents the virtual machine 30 (VMn), and generated using the use histories of the users that share the virtual machine 30 (VMn).

Generation of reference use history information will be described.

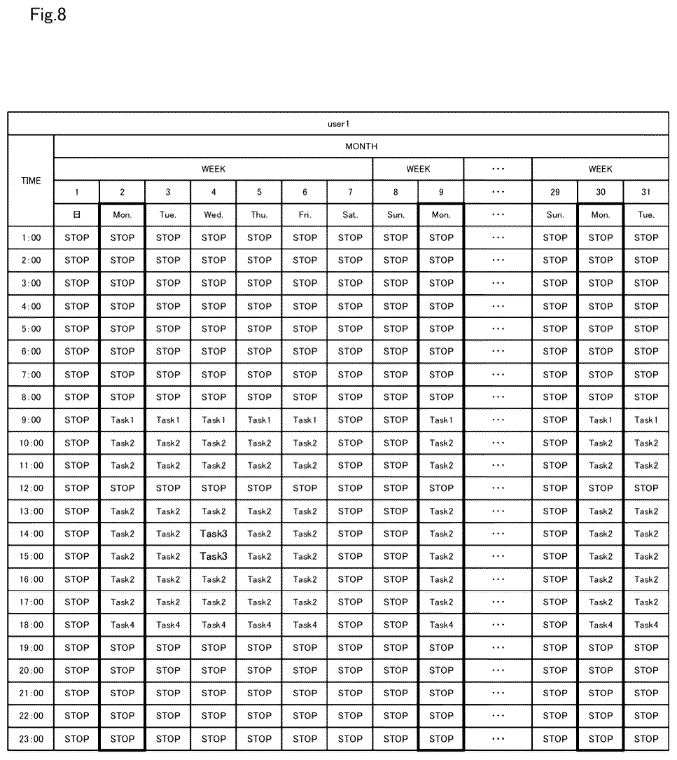

FIG. 8 is a diagram for describing an example of use histories. The table in FIG. 8 shows monthly use history (“history 1” in FIG. 7) of the user (user 1). “STOP” in Table 8 indicates a period (unused period) in which the user is not using the virtual machine, and “Task 1”, “Task 2”, “Task 3”, and “Task 4” indicate use contents that depend on use specifying information (type information and identification information), use period information, and operation identification information. Note that the use contents are not limited to the above four types.

“Task 1” indicates type information “event”, identification information “login”, and operation identification information “-”, for example. “Task 2” indicates type information “file”, identification information “app 2”, and operation identification information “write”, for example. “Task 3” indicates type information “app”, identification information “app 1”, and operation identification information “read”, for example. “Task 4” indicates type information “event”, identification information “logout”, and operation identification information “-”, for example.

Note that the table of monthly use histories (“history 2” to “history N+2” in FIG. 7) of user (users 2 to N+2) in FIG. 2 is also a table in a format similar to the above table of the user (user 1).

Description of Daily Reference Use History Information

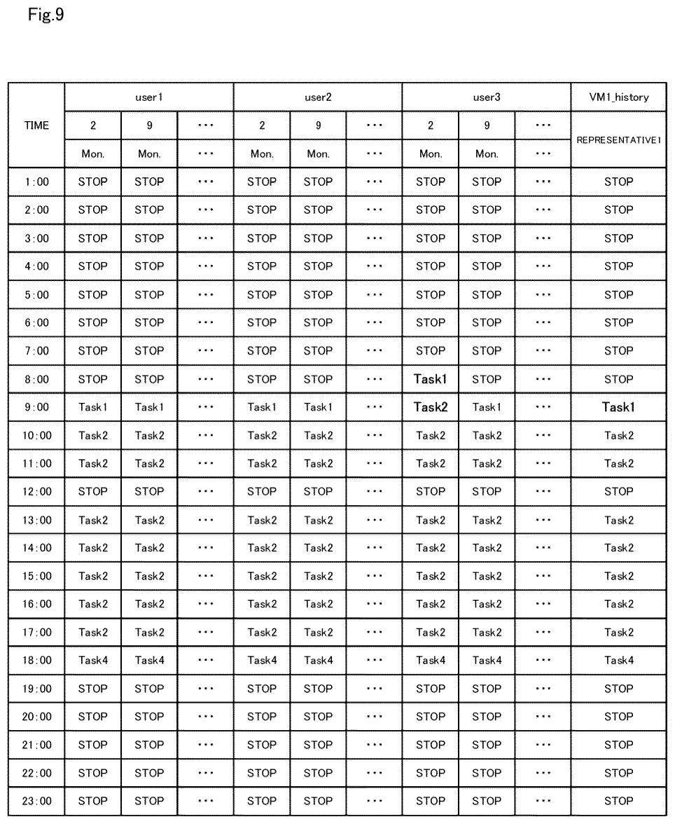

FIG. 9 is a diagram for describing generation of daily reference use history information. FIG. 9 shows an example in which use contents in the 24-hour period on Monday by the users (users 1 to 3) that share the virtual machine 30 (VM1) are averaged to create daily reference use history information VMn_history (representative 1).

In the example in FIG. 9, the use contents of the users (users 1 to 3) on Monday are substantially the same, but only the user (user 3) is logged in in a period from 8:00 to 9:00 on Monday, 2^{nd} of month (Task 1), and uses the virtual machine 30 (VM1) in a period from 9:00 to 10:00 (Task 2). Therefore, in the reference use history information VM1_history, the period from 8:00 to 9:00 is set as an unused period (STOP) and a period from 9:00 to 10:00 is set as login (Task 1) by majority vote.

In the above example, use contents in the 24-hour periods of a plurality of same days (2^{nd}, 9^{th}, . . . ) are averaged for each of the users (users 1 to 3), but use contents in the 24-hour period of a single day (for example, 2^{nd} or 9^{th}) may be averaged to generate the reference use history information VM1_history.

Description of Weekly Reference Use History Information

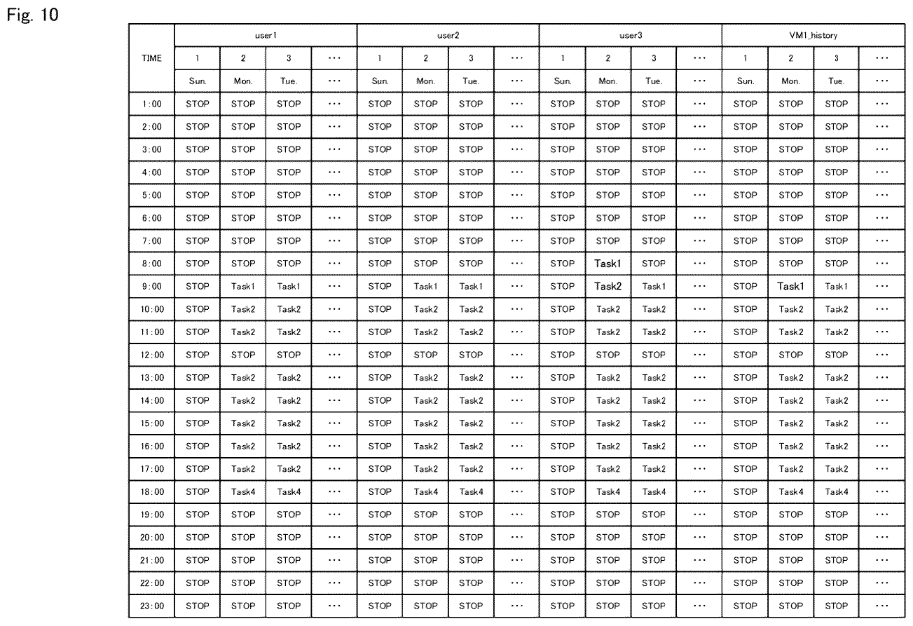

FIG. 10 is a diagram for describing generation of weekly reference use history information. FIG. 10 shows an example in which use contents on the same date of the same week by the users (users 1 to 3) that share the virtual machine 30 (VM1) are averaged to create weekly reference use history information VMn_history (representative 1). It is desirable to use a week that is close to the current point in time, from among past weeks.

Description of Monthly Reference Use History Information

Uses on the same date of the same month by the users (users 1 to 3) that share the virtual machine 30 (VM1) may be averaged to create monthly reference use history information VMn_history (representative 1).

In addition, also for virtual machines 30 (VM2 . . . VMn), VMn_history (representative n) is generated from the reference use history information VM2_history (representative 2) as described above.

The first extraction unit 13 calculates first similarities between reference use history information of the virtual machine 30 and pieces of use history information of a plurality of users that share the virtual machine 30.

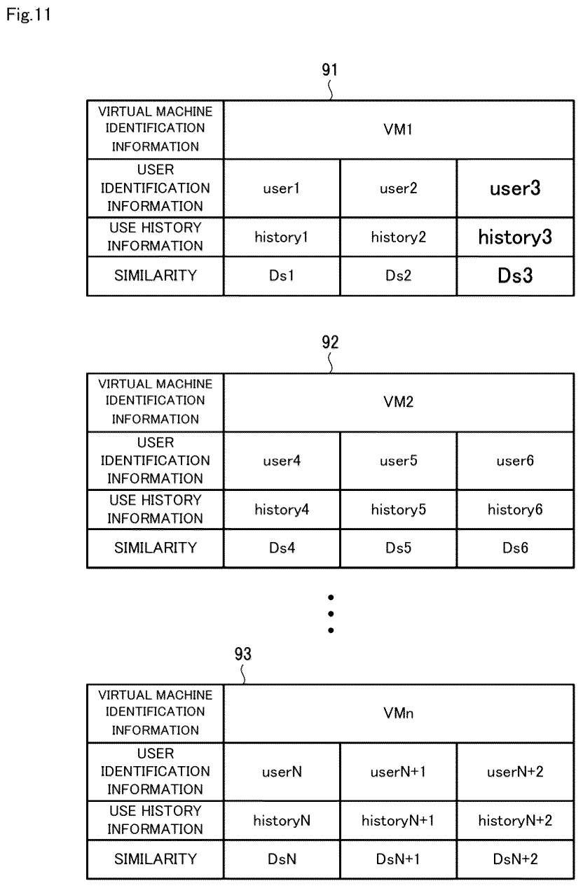

FIG. 11 is a diagram for describing first similarities. In the example in FIG. 11, Table 91 shows first similarities Ds1, Ds2, and Ds3 between reference use history information (VM1_history (representative 1)) of the virtual machine 30 (VM1) and use history information (“history 1”, “history 2”, and “history 3”) of a plurality of users (users 1 to 3) that share the virtual machine 30 (VM1).

Table 92 shows first similarities Ds4, Ds5, and Ds6 between reference use history information (VM2_history (representative 2)) of the virtual machine 30 (VM2) and use history information (“history 4”, “history 5”, and “history 6”) of a plurality of users (users 4 to 6) that share the virtual machine 30 (VM2).

Table 93 shows first similarities DsN, DsN+1, and DsN+2 between reference use history information (VMn_history (representative n)) of the virtual machine 30 (VMn) and use history information (“history N”, “history N+1”, and “history N+2”) of a plurality of users (users N to N+2) that share the virtual machine 30 (VMn).

First distances between reference use history information and pieces of use history information are calculated for each virtual machine 30, and the calculated first distances are used as first similarities, for example.

It is conceivable that, for example, in the case of Ds1, the number of differences of each element between user 1 and history (representative 1) in FIG. 10 is used as a first distance.

Note that, the larger the distance is, the lower the similarity to the reference use history information becomes (the larger the deviation from the average becomes).

Next, the first extraction unit 13 detects the first similarities Ds that are lower than or equal to a first threshold value Th1 set in advance, among the calculated first similarities, for each virtual machine 30, and extracts first users corresponding to the detected first similarity Ds.

It is conceivable to use, as the first threshold value Th1, the distance values that are the longest 10[%] and for which the first distance is long, based on results obtained in the first one month since the above system 100 was introduced, for example. Alternatively, the first threshold value Th1 is determined based on testing, simulation, and the like.

In the example in FIG. 11, the first extraction unit 13 extracts a first user (user 3) that has use histories (history 3) that are not similar to the reference use history information (VM1_history (representative 1)) of the virtual machine 30 (VM1).

The second extraction unit 14 calculates second similarities between the reference use history information of each of the other virtual machines 30 and the extracted pieces of use history information of the first user.

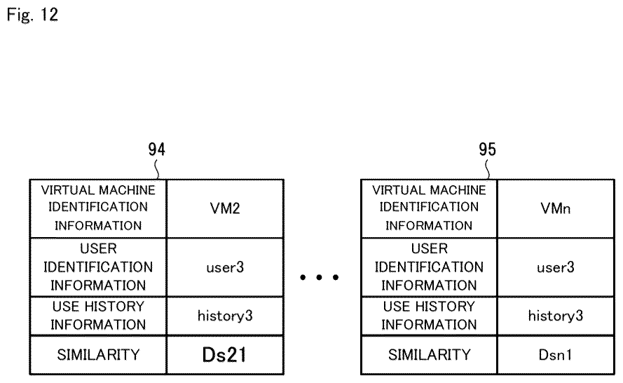

FIG. 12 is a diagram for describing second similarities. Tables 94 and 95 in FIG. 12 show second similarities Ds21 . . . Dsn1 between the first user (user 3) of the virtual machine 30 (VM1) extracted in the example in FIG. 11 and the reference use history information (VM2_history (representative 2) to VMn_history (representative n)) of other virtual machines 30 (VM2 to VMn).

The second distances between reference use history information of each of the other virtual machines 30 and the pieces of use history information of the first users are calculated, and the calculated second distances are used as second similarities, for example.

It is conceivable that, for example, in the case of Ds21, the number of differences of each element between user 3 and history (representative 2) in FIG. 10 is used as a second distance.

Note that the shorter the distance is, the larger the similarity to the reference use history information becomes (the smaller the deviation from average becomes).

Next, the second extraction unit 14 detects a second similarity that is equal to or larger than a second threshold value Th2 set in advance, from among the calculated second similarities, and extracts second users corresponding to the detected second similarity, and virtual machine 30 corresponding to the second users.

It is conceivable to use, as the second threshold value Th2, the distance values that are the longest 10[%] and for which the first distance is long, based on results obtained in the first one month since the above system 100 was introduced, for example. Alternatively, the second threshold value Th2 is determined based on testing, simulation, and the like.

Assume that, in the example in FIG. 12, the use history (history 3) of the first user (user 3) is similar to the reference use history information (VM2_history (representative 2)) of the virtual machine 30 (VM2). That is to say, assume that the similarity “Ds21” in Table 94 in FIG. 12 is equal to or larger than the second threshold value Th2.

Next, the second extraction unit 14 notifies the terminal apparatus 20 of the administrator that manages the multi-session software, that there is another virtual machine 30 that has a large number of users performing uses that are similar to the use content of the second user. The administrator then changes the connection between the virtual machine 30 and terminal apparatuses 20 of the users, based on the notification.

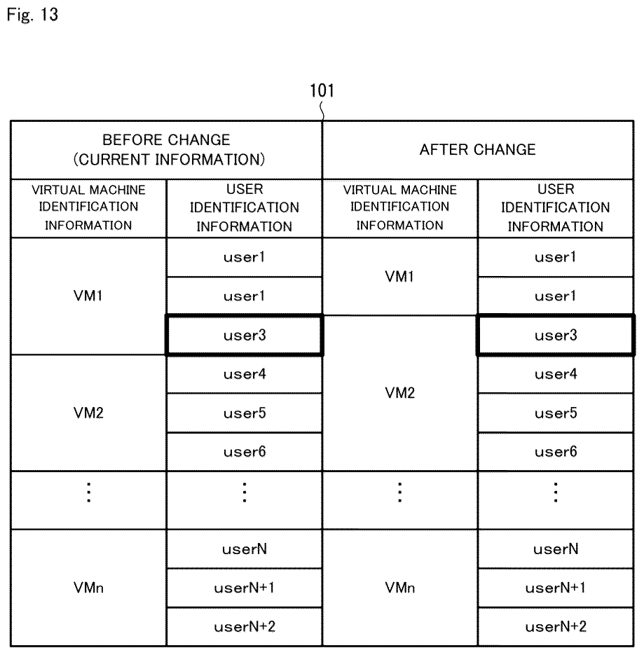

FIG. 13 is a diagram for describing the content of the notification. FIG. 13 shows information 101 (the content of the notification) indicating the sharing relation between virtual machines 30 and users, before change (current information) and after change. In addition, the use history (history 3) of the first user (user 3) is similar to the reference use history information (VM2_history (representative 2)) of the virtual machine 30 (VM2) as in FIG. 12, and thus the information 101 in FIG. 13 shows a notification indicating that the virtual machine 30 that is shared by first user (user 3) can be changed to the virtual machine 30 (VM2).

Next, the administrator manually changes the connection between virtual machine 30 and the terminal apparatus 20 of the user based on the notification. Alternatively, the connection between the virtual machine 30 and the terminal apparatus 20 of the user may be automatically changed based on a notification content.

### [Apparatus Operation]

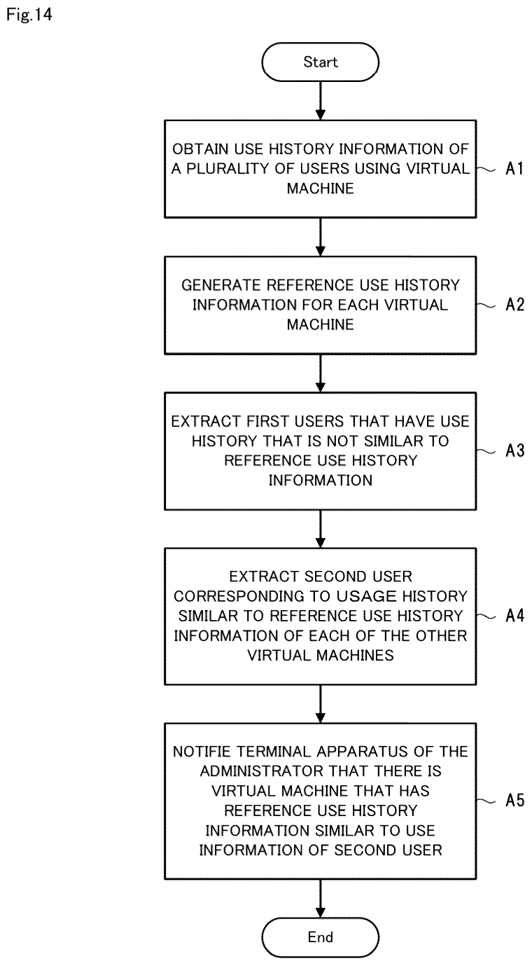

Operations of the information processing apparatus described in the above (B) according to the example embodiment will be described with reference to FIG. 14. FIG. 14 is a diagram for describing operations of the information processing apparatus. In the following description, the diagrams will be referenced as appropriate. In addition, in the example embodiment, an information processing method is performed by operating the information processing apparatus. Thus, description of the information processing method according to the example embodiment is replaced with the following description of the operations of the information processing apparatus.

As shown in FIG. 14, the obtaining unit 11 obtains use history information indicating use histories of a plurality of users that use each virtual machine 30 in which multi-session software that is accessed and used by a plurality of users is installed (step A1).

Next, the generation unit 12 generates reference use history information indicating a use history serving as a reference that represents each virtual machine 30, using use histories of a plurality of users that share the virtual machine 30 (step A2).

Specifically, as described in the above generation of reference use history information, in step A2, the generation unit 12 averages use contents of a plurality of users that share the virtual machine, using the use histories of the users in a period set in advance, and generates reference use history information.

Next, the first extraction unit 13 extracts users (first users) that have a use history that is not similar to the reference use history information of the target virtual machine 30 (step A3).

Specifically, in step A3, the first extraction unit 13 first calculates first similarities between the reference use history information of the virtual machine 30 and pieces of use history information of a plurality of users that share the virtual machine 30.

Next, in step A3, for each virtual machine 30, the first extraction unit 13 detects a first similarity that is equal to or smaller than the first threshold value Th1 set in advance, from among the calculated first similarities, and extracts first users corresponding to the detected first similarity.

Next, the second extraction unit 14 compares the reference use history information of each of the virtual machines 30 other than the target virtual machine 30, with the use histories of the extracted first users, and extracts a first user (second user) corresponding to a similar use history (step A4).

Specifically, in step A4, the second extraction unit 14 first calculates second similarities between the reference use history information of each of the other virtual machine 30 and pieces of use history information of the extracted first users.

Next, in step A4, the second extraction unit 14 detects a second similarity that is equal to or larger than the second threshold value Th2 set in advance, from among the calculated second similarities, and extracts a second user corresponding to the detected second similarity and another virtual machine 30 corresponding to the second user.

Next, the second extraction unit 14 notifies the terminal apparatus 20 of the administrator that there is a virtual machine that has reference use history information similar to use information of the second user (step A5). Specifically, in step A5, the second extraction unit 14 notifies the terminal apparatus 20 of the administrator that manages the multi-session software that there is another virtual machine 30 that has a large number of users performing use similar to use by the second user.

Next, the administrator manually changes the connection between the virtual machine 30 and the terminal apparatus 20 of the user based on the notification. Alternatively, the connection between the virtual machine 30 and the terminal apparatus 20 of the user may be automatically changed based on a notification content.

Note that, in the embodiment, the above processing of steps A1 to A5 is repeatedly executed each time a security patch is distributed from a vendor, for example. Alternatively, the processing of steps A1 to A5 is repeatedly executed on regular basis.

[Effects of Example Embodiment]

As described above, in the embodiment, when a security patch that requires a restart is applied to multi-session software, influence on users can be reduced.

In addition, the sharing relation between users and virtual machines 30 can be changed based on similarity in use content, and thus a restart of the virtual machine 30 can be efficiently executed. That is to say, use contents of users that share each virtual machine 30 are similar, and thus the restart of the virtual machine 30 can be efficiently executed.

[Program]

A program according to the above (B) of the example embodiment may be a program that causes a computer to execute steps A1 to A5 shown in FIG. 14. It is possible to realize the information processing apparatus and the information processing method according to the example embodiment by installing this program onto a computer and executing the program. If this is the case, the processor of the computer functions as the obtaining unit 11, the generation unit 12, the first extraction unit 13, and the second extraction unit 14, and performs processing.

Also, the processor of the computer functions as the collecting unit 31, the restart execution unit 32, the storage unit 33, the management unit 41, the detection unit 42, the restart instruction unit 43, and the storage unit 44, and performs processing.

Also, the program according to the above (B) of the example embodiment may be executed by a computer system that is constituted by a plurality of computers. If this is the case, for example, each computer may function as any of the obtaining unit 11, the generation unit 12, the first extraction unit 13, and the second extraction unit 14.

Also, each computer may function as any of the collecting unit 31, the restart execution unit 32, the storage unit 33, the management unit 41, the detection unit 42, the restart instruction unit 43, and the storage unit 44, and performs processing.

[Physical Configuration]

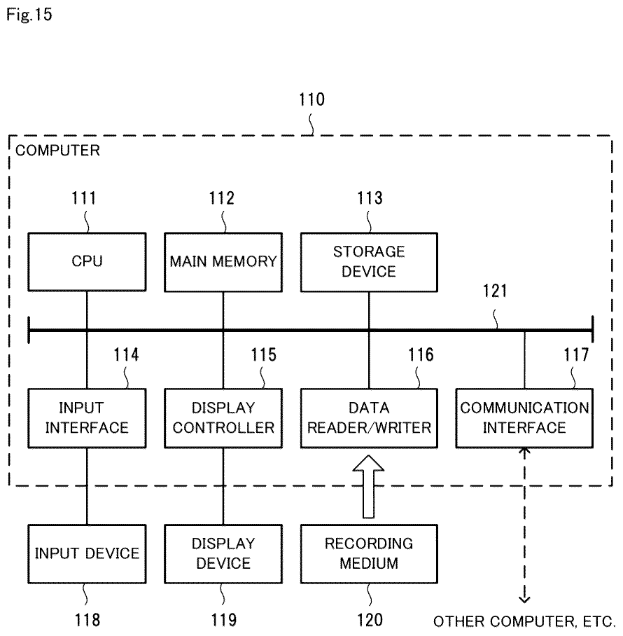

Here, a computer that executes a program according to the example embodiment to realize an information processing apparatus will be described with reference to FIG. 15. FIG. 15 is a diagram for describing an example of a computer that realizes the information processing apparatus.

As shown in FIG. 15, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU (Graphics Processing Unit) or a FPGA (Field-Programmable Gate Array) in addition to the CPU 111 or instead of the CPU 111.

The CPU 111 loads a program (codes) according to the present exemplary embodiment stored in the storage device 113 to the main memory 112, and executes them in a predetermined order to perform various kinds of calculations. The main memory 112 is typically a volatile storage device such as a DRAM (Dynamic Random Access Memory). Also, the program according to the present exemplary embodiment is provided in the state of being stored in a computer-readable recording medium 120. Note that the program according to the present exemplary embodiment may be distributed on the Internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The information processing apparatus according to the example embodiment can also be achieved using hardware corresponding to the components, instead of a computer in which a program is installed. Furthermore, a part of the information processing apparatus may be realized by a program and the remaining part may be realized by hardware.

Although the invention of this application has been described with reference to the example embodiment, the invention of this application is not limited to the above example embodiment. Within the scope of the invention of this application, various changes that can be understood by those skilled in the art can be made to the configuration and details of the invention of this application.

As described above, according to the present disclosure, when a security patch that requires a restart is applied to software that supports the multi-session model, influence on users can be reduced. In addition, it is useful in a technical field in which restarting of virtual machines is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
an obtaining unit that obtains, for each of a plurality of computers in which software that supports a multi-session model and is accessed and used by a plurality of users is installed, use history information indicating use histories of the users that use the computers;
a generation unit that generates, for each computer, reference use history information indicating a use history serving as a reference for the computer, using the use history information of the users that use the computer; and
an extraction unit that calculates, for each user that uses the computers, similarities between the use history information of the user and the pieces of reference use history information of the computers, and extracting a computer corresponding to the user based on the similarities.

2. The information processing apparatus according to claim 1,
wherein the extraction unit includes:
a first extraction unit that calculates first similarities between the reference use history information of each computer and the pieces of use history information of the plurality of users that use the computer, detects a first similarity that is equal to or smaller than a first threshold value set in advance, from among the calculated first similarities, and extracts first users corresponding to the detected first similarity, and
a second extraction unit that calculates second similarities between the reference use history information of each of the other computers and the pieces of use history information of the extracted first users, detects a second similarity that is equal to or larger than a second threshold value set in advance, from among the calculated second similarities, and extracts a second user corresponding to the detected second similarity and a computer corresponding to the second user.

3. The information processing apparatus according to claim 2,
wherein the generation unit generates the reference use history information by averaging use contents of the users that share the computer, using the use histories of the users in a period set in advance.

4. The information processing apparatus according to claim 3,
wherein the generating unit detects a use content that occurs on an irregular basis, from the pieces of use history information of the users that share the computer, and replaces the detected use content with a use content implemented by a large number of the users in a time corresponding to the detected use content.

5. The information processing apparatus according to claim 4,
wherein the first extraction unit calculates first distances between the reference use history information of each computer and the pieces of use history information, and sets the calculated first distances as the first similarities.

6. The information processing apparatus according to claim 5,
wherein the second extraction unit calculates second distances between the reference use history information of each of the other computers and the use history information of each of the first users, and sets the calculated second distances as the second similarities.

7. The information processing apparatus according to claim 6,
wherein the second extraction unit transmits notification indicating that there is another computer shared by a large number of users performing use that is similar to a use status of the second user, to a terminal apparatus of an administrator that manages software that supports the multi-session model.

8. An information processing method that is performed by an information processing apparatus, the method comprising:
obtaining, for each of a plurality of computers in which software that supports a multi-session model and is accessed and used by a plurality of users is installed, use history information indicating use histories of the users that use the computers;
generating, for each computer, reference use history information indicating a use history serving as a reference for the computer, using the use history information of the users that use the computer; and
calculating, for each user that uses the computers, similarities between the use history information of the user and the pieces of reference use history information of the computers, and extracting a computer corresponding to the user based on the similarities.

9. A non-transitory computer-readable recording medium that includes a program recorded thereon, the program including instructions that causes a computer to carry out the steps of:
obtaining, for each of a plurality of computers in which software that supports a multi-session model and is accessed and used by a plurality of users is installed, use history information indicating use histories of the users that use the computers;
generating, for each computer, reference use history information indicating a use history serving as a reference for the computer, using the use history information of the users that use the computer; and
calculating, for each user that uses the computers, similarities between the use history information of the user and the pieces of reference use history information of the computers, and extracting a computer corresponding to the user based on the similarities.
